(19) United States
(12) Patent Application Publication
(10) Pub. No.: US 2026/0155620 A1
(43) Pub. Date: Jun. 4, 2026

(54) OPTICAL ELEMENT AND ALIGNMENT METHOD

(71) Applicant: NEC Corporation, Tokyo (JP)

(72) Inventor: Naoki KOBAYASHI, Tokyo (JP)

(73) Assignee: NEC Corporation, Tokyo (JP)

(21) Appl. No.: 19/379,979

(22) Filed: Nov. 5, 2025

(30) Foreign Application Priority Data
Nov. 29, 2024 (JP) 2024-208956

(51) Int. Cl. H01S 3/10; H01S 3/13

(52) U.S. Cl. CPC H01S 3/1003; H01S 3/1301

(57) ABSTRACT

A wavelength control unit performs wavelength filtering on input light guided by a first optical waveguide and outputs output light. An output light intensity monitoring unit monitors an intensity of the output light guided by a second optical waveguide. A third optical waveguide is spaced apart from and parallel to the first optical waveguide in a first direction. A fourth optical waveguide is spaced apart from and parallel to the second optical waveguide in a second direction. First and second reference light intensity monitoring units monitor intensities of first and second reference lights input to the third and fourth optical waveguides. End faces of the first and third optical waveguides belong to a first surface. End faces of the second and fourth optical waveguides belong to a second surface.

### INCORPORATION BY REFERENCE

This application is based upon and claims the benefit of priority from Japanese patent application No. 2024-208956, filed on Nov. 29, 2024, the disclosure of which is incorporated herein in its entirety by reference.

### TECHNICAL FIELD

The present disclosure relates to an optical element and an alignment method.

### BACKGROUND ART

In assembling an optical module and the like, a technique for aligning an optical element and another optical component with high accuracy is used. For example, in the case of configuring a wavelength-tunable light source, work of aligning a light emitting element and an optical amplifier is performed on an optical element provided with a wavelength filter.

For example, Japanese Unexamined Patent Application Publication No. 2018-194675 proposes a method of aligning a light emitting element with respect to an optical element while monitoring intensity of light incident from the light emitting element by a light receiving means provided in the optical element. In this method, the light intensity is monitored while the light emitting element is moved with respect to the optical element. Then, the light emitting element is held at a position where the light intensity becomes a sufficiently large value, for example, the maximum.

### SUMMARY

However, in a case where a wavelength-tunable light source including a light emitting element, an optical element provided with a wavelength filter, and an optical amplifier that amplifies output light from the optical element is configured, it is required to align the light emitting element and the optical amplifier with respect to the optical element. In this case, first, the light emitting element is aligned with respect to the optical element. Then, the output light from the optical element amplified by the optical amplifier is monitored to align the optical amplifier with the optical element. Therefore, the alignment work of the light emitting element and the alignment work of the optical amplifier need to be performed separately in order, and it takes a long time to perform the alignment in the wavelength-tunable light source.

An optical element according to an example aspect of the present disclosure includes a first optical waveguide into which input light is incident, a wavelength control means for performing wavelength filtering on the input light guided by the first optical waveguide and outputting output light having a desired wavelength, a second optical waveguide that guides the output light, an output light intensity monitoring means for monitoring an intensity of the output light guided by the second optical waveguide, a third optical waveguide provided to be spaced apart from the first optical waveguide along a first direction intersecting a direction in which the first optical waveguide extends, the third optical waveguide being parallel to the first optical waveguide, a first reference light intensity monitoring means for monitoring an intensity of first reference light input to the third optical waveguide, a fourth optical waveguide provided to be spaced apart from the second optical waveguide along a second direction intersecting a direction in which the second optical waveguide extends, the fourth optical waveguide being parallel to the second optical waveguide, and a second reference light intensity monitoring means for monitoring an intensity of second reference light input to the fourth optical waveguide, wherein an end face on which the input light is incident in the first optical waveguide and an end face on which the first reference light is input in the third optical waveguide belong to a first surface parallel to the first direction and a third direction orthogonal to the first direction and the direction in which the first and third optical waveguides extend, and an end face from which the output light is emitted in the second optical waveguide and an end face to which the second reference light is input in the fourth optical waveguide belong to a second surface parallel to the second direction and a fourth direction orthogonal to the second direction and the direction in which the second and fourth optical waveguides extend.

An alignment method according to an example aspect of the present disclosure, with respect to an optical element, the optical element comprising: a first optical waveguide that guides input light; a wavelength control means for performing wavelength filtering on the input light guided by the first optical waveguide and outputting output light having a desired wavelength; a second optical waveguide that guides the output light; an output light intensity monitoring means for monitoring an intensity of the output light guided by the second optical waveguide; a third optical waveguide provided to be spaced apart from the first optical waveguide by a first distance along a first direction intersecting a direction in which the first optical waveguide extends, the third optical waveguide being parallel to the first optical waveguide; a first reference light intensity monitoring means for monitoring an intensity of first reference light input to the third optical waveguide; a fourth optical waveguide provided to be spaced apart from the second optical waveguide by a second distance along a second direction intersecting a direction in which the second optical waveguide extends, the fourth optical waveguide being parallel to the second optical waveguide; and a second reference light intensity monitoring means for monitoring an intensity of second reference light input to the fourth optical waveguide, in which an end face on which the input light is incident in the first optical waveguide and an end face on which light is input in the third optical waveguide belonging to a first surface parallel to the first direction and a third direction orthogonal to the first direction and the direction in which the first and third optical waveguides extend, and an end face from which the output light is emitted in the second optical waveguide and an end face to which the second reference light is input in the fourth optical waveguide belonging to a second surface parallel to the second direction and a fourth direction orthogonal to the second direction and the direction in which the second and fourth optical waveguides extend, the alignment method comprising: performing a first alignment for aligning a first element capable of outputting light and a second alignment for aligning a second element capable of outputting light in parallel; in the first alignment, adjusting a position of the first element with respect to the third optical waveguide while the first reference light intensity monitoring unit monitors an intensity of the first reference light in a state where the first reference light is output from the first element to the third optical waveguide; holding the first element at a position where the intensity of the first reference light falls within a predetermined first range; moving the first element by the first distance in a direction from a position where the first element is held toward the first optical waveguide along the first direction; in the second alignment, adjusting a position of the second element with respect to the fourth optical waveguide while the second reference light intensity monitoring unit monitors an intensity of the second reference light in a state where the second reference light is output from the second element to the fourth optical waveguide; holding the second element at a position where the intensity of the second reference light falls within a predetermined second range; and moving the second element by the second distance in a direction from a position where the second element is held toward the second optical waveguide along the second direction.

According to the present disclosure, alignment of opposing optical paths can be efficiently performed.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a top view schematically illustrating a configuration of an optical element according to one example embodiment;

FIG. 2 is a top view schematically illustrating a configuration of a wavelength-tunable light source including an optical element according to one example embodiment and peripheral components thereof;

FIG. 3 is a flowchart of alignment work according to one example embodiment;

FIG. 4 is a diagram schematically illustrating an arrangement of an optical element, a light emitting element, and an optical amplifier at the start of alignment;

FIG. 5 is a diagram illustrating an example of alignment work of a light emitting element and an optical amplifier;

FIG. 6 is a diagram illustrating an example of performing alignment by moving a light emitting element and an optical amplifier;

FIG. 7 is a top view schematically illustrating a configuration of an optical element according to one example embodiment; and

FIG. 8 is a top view schematically illustrating a configuration of an optical element according to one example embodiment.

### EXAMPLE EMBODIMENTS

Hereinafter, example embodiments of the present invention will be described with reference to the drawings. In the drawings, the same elements are denoted by the same reference signs, and redundant description will be omitted as necessary.

Hereinafter, the term “one example embodiment” means that it is applicable to any of the example embodiments described below or a combination of two or more example embodiments, and the application is not limited to a specific example embodiment.

### First Example Embodiment

An optical element according to the present example embodiment will be described. The optical element according to the present example embodiment is an element including an optical circuit that performs wavelength filtering on light input from an external light emitting element and outputs light having a predetermined wavelength to an external optical amplifier. The optical element according to the present example embodiment may be configured as a silicon photonics (SiP) element formed on a silicon substrate. The optical element according to the present example embodiment has a configuration capable of easily performing alignment of an external light emitting element and an optical amplifier with respect to an optical waveguide provided in the optical element.

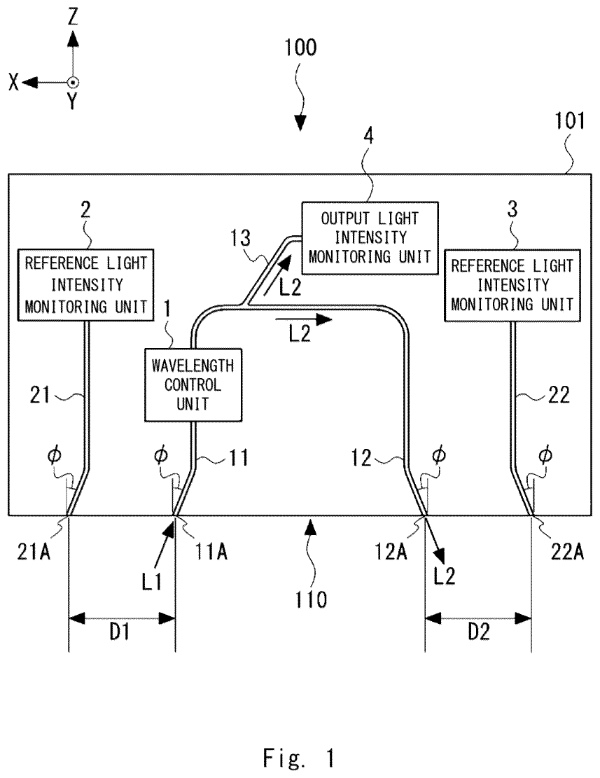

FIG. 1 is a top view schematically illustrating a configuration of an optical element according to one example embodiment. An optical element 100 is an element including an optical circuit formed on a substrate 101. The substrate 101 may be, for example, a silicon substrate. The optical element 100 performs wavelength filtering on input light L1 output from an external light emitting element. Then, the optical element 100 outputs output light L2 having a desired wavelength to an external optical amplifier.

In FIG. 1, an X axis, a Y axis, and a Z axis in a three-dimensional orthogonal coordinate system are displayed for clarity of description. In FIG. 1, the horizontal direction to the left in the drawing is defined as the X-axis direction. A normal direction toward the front side with respect to the drawing is defined as a Y-axis direction. An upward vertical direction in the drawing is defined as a Z-axis direction. In FIG. 1, an end face 110 of the optical element 100 is a surface parallel to the X-Y plane. The display of the X axis, the Y axis, and the Z axis in the drawings is similar in the following drawings.

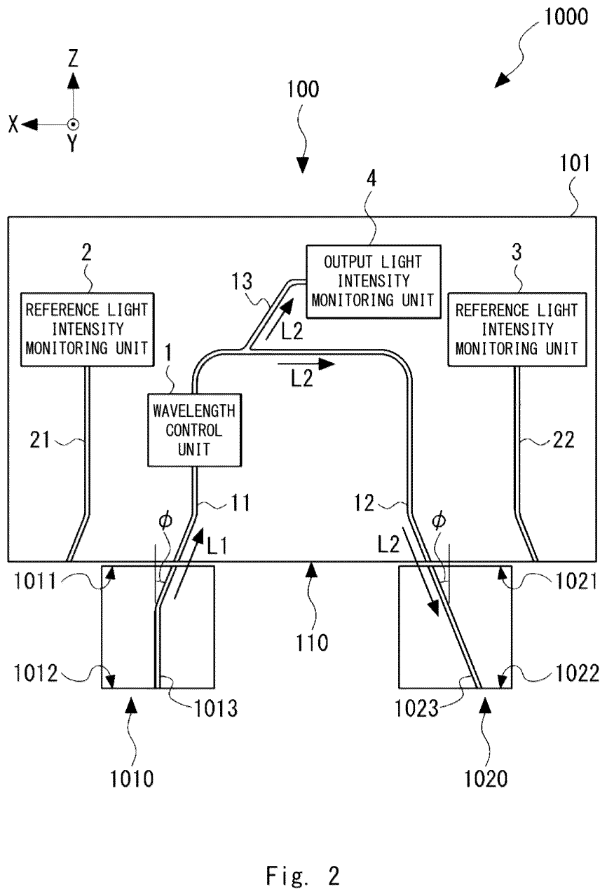

FIG. 2 is a top view schematically illustrating a configuration of a wavelength-tunable light source including an optical element according to one example embodiment and peripheral components thereof. A wavelength-tunable light source 1000 includes the optical element 100, a light emitting element 1010, and an optical amplifier 1020. The light emitting element 1010 and the optical amplifier 1020 may be configured as, for example, a semiconductor optical amplifier. End faces 1011 and 1012 of the light emitting element 1010 and end faces 1021 and 1022 of the optical amplifier 1020 are surfaces parallel to the X-Y plane. Hereinafter, the light emitting element 1010 is also referred to as a first element. The optical amplifier 1020 is also referred to as a second element.

The light emitting element 1010 is provided with an optical waveguide 1013 extending between the end faces 1011 and 1012. An antireflection film (not illustrated) is formed on the end face 1011 facing the end face 110 of the optical element 100. A highly reflective film (not illustrated) is formed on the end face 1012 opposite to the end face 1011. The optical waveguide 1013 is formed so as to be inclined by a predetermined angle with respect to the end face 1011 in order to prevent the influence of the reflection of the input light L1 on the end face 1011. In this example, in the vicinity of the end face 1011, the optical waveguide 1013 extends in a direction inclined by φ in the clockwise direction with respect to the Z-axis direction which is the normal direction of the end face 1011. The optical waveguide 1013 is provided with a gain region. In the light emitting element 1010, for example, light is emitted by injecting a current into the gain region of the optical waveguide 1013, whereby the input light L1 is guided by the optical waveguide 1013. The input light L1 guided by the optical waveguide 1013 is emitted from the end face 1011 to the optical element 100.

The optical element 100 includes a wavelength control unit 1, reference light intensity monitoring units 2 and 3, an output light intensity monitoring unit 4, and optical waveguides 11 to 13, 21, and 22. The optical waveguides 11 to 13, 21, and 22 are formed on the substrate 101. In a case where the optical element 100 is configured as a SiP element, the substrate 101 is configured as a silicon substrate. The optical waveguides 11 to 13, 22, and 22 are configured as, for example, silicon oxide (SiO₂) optical waveguides. The reference light intensity monitoring units 2 and 3 and the output light intensity monitoring unit 4 may include, for example, a photodiode. Hereinafter, the optical waveguides 11 and 12 are also referred to as first and second optical waveguides.

The input light L1 emitted from the light emitting element 1010 enters the optical waveguide 11 via an end face 11A. An antireflection film (not illustrated) may be formed on the end face 11A. The end face 11A is provided so as to belong to the same surface as the end face 110 of the optical element. The optical waveguide 11 extends in a direction inclined by φ in the clockwise direction with respect to the normal direction of the end face 11A in order to guide the input light L1 from the optical waveguide 1013 inclined with respect to the end face 1011 of the light emitting element 1010. As a result, by appropriately aligning the optical waveguide 1013 of the light emitting element 1010 and the optical waveguide 11 of the optical element 100, the input light L1 smoothly enters the optical waveguide 11 from the optical waveguide 1013.

The input light L1 incident on the optical waveguide 11 is incident on the wavelength control unit 1. The wavelength control unit 1 performs wavelength filtering on the input light L1 and emits the output light L2 having a desired wavelength to the optical waveguide 12. The wavelength control unit 1 may be configured as, for example, a wavelength filter having a general double ring resonator structure. In this example, the effective refractive index of the optical waveguide is adjusted by applying a voltage to an electrode provided in the optical waveguide constituting the ring resonator or driving a heater provided in the vicinity of the ring resonator. As a result, the resonance state of the light can be controlled to control the wavelength of the oscillating light to a desired wavelength.

The configuration of the wavelength control unit 1 in FIG. 2 is merely an example, and the wavelength control unit 1 may have another configuration as long as the input light L1 can be wavelength-filtered and the output light L2 having a desired wavelength can be emitted to the optical waveguide 12.

The optical waveguide 12 is formed so as to be inclined by a predetermined angle with respect to an end face 12A in order to prevent the influence of the reflection of the output light L2 on the end face 12A. The end face 12A is provided so as to belong to the same surface as the end face 110 of the optical element. In this example, in the vicinity of the end face 12A, the optical waveguide 12 extends in a direction inclined by φ in the counterclockwise direction with respect to the normal direction of the end face 12A. The output light L2 is emitted from the end face 12a to the optical amplifier 1020.

The optical waveguide 12 is branched between the wavelength control unit 1 and the end face 12A and connected to the optical waveguide 13. A part of the output light L2 is branched from the optical waveguide 12 to the optical waveguide 13 and enters the output light intensity monitoring unit 4. The output light intensity monitoring unit 4 receives the incident output light L2. As a result, the output light intensity monitoring unit 4 monitors the intensity of the output light L2.

The optical amplifier 1020 is provided with an optical waveguide 1023 extending between the end faces 1021 and 1022. An antireflection film (not illustrated) is formed on the end face 1012 facing the end face 110 of the optical element 100. An antireflection film (not illustrated) is also formed on the end face 1022 opposite to the end face 1021. In order to prevent the influence of the reflection on the end face 1022 of the output light L2 emitted from the optical waveguide 12 of the optical element 100, the optical waveguide 1023 is formed so as to be inclined by a predetermined angle with respect to the end faces 1021 and 1022. In this example, the optical waveguide 1023 extends in a direction inclined by φ in the counterclockwise direction with respect to the Z-axis direction which is the normal direction of the end faces 1021 and 1022. The optical waveguide 1023 is provided with a gain region. In the optical amplifier 1020, for example, carriers in an excited state are generated by injecting a current into the gain region of the optical waveguide 1023. As a result, the output light L2 guided by the optical waveguide 1023 is amplified to a desired intensity. The amplified output light L2 is emitted from the end face 1022 to the outside.

In the optical element 100, the optical waveguide 21 extending between an end face 21A and the reference light intensity monitoring unit 2 is further provided in the vicinity of the optical waveguide 11. The end face 21A is provided so as to belong to the same surface as the end face 110 of the optical element 100. Similarly to the optical waveguide 11, the optical waveguide 21 is formed as an optical waveguide parallel to the optical waveguide 11 to which the input light L1 can be incident from the light emitting element 1010. Therefore, similarly to the optical waveguide 11, the optical waveguide 21 extends in a direction inclined by the angle φ in the clockwise direction with respect to the Z-axis direction which is the normal direction of the end face 21A. The optical waveguide 21 is provided at a position separated from the optical waveguide 11 by a distance D1 in the +X-axis direction intersecting the extending direction of the optical waveguide 21 on the substrate 101.

Hereinafter, the optical waveguide 21 is also referred to as a third optical waveguide. A direction parallel to the X axis in which the optical waveguide 11 is separated from the optical waveguide 21 is also referred to as a first direction. A surface parallel to the X-Y plane to which the end faces 110, 11A, and 21A belong is also referred to as a first surface. The Y-axis direction, which is an axis of inclination in the extending direction of the optical waveguide 21 with respect to the first surface to which the end face 21A of the optical waveguide 21 belongs, is referred to as a third direction. The clockwise angle φ indicating the inclination of the optical waveguide 21 is also referred to as a first angle.

The reference light intensity monitoring unit 2 receives the input light L1 entering the optical waveguide 21 as reference light for aligning the light emitting element 1010. As a result, the reference light intensity monitoring unit 2 monitors the intensity of the input light L1 that is the reference light. Hereinafter, the input light L1 incident from the light emitting element 1010 to the optical waveguide 21 as reference light is also referred to as first reference light. The reference light intensity monitoring unit 2 is also referred to as a first reference light intensity monitoring unit.

In the optical element 100, the optical waveguide 22 extending between an end face 22A and the reference light intensity monitoring unit 3 is provided in the vicinity of the optical waveguide 12. The end face 22A is provided so as to belong to the same surface as the end face 110 of the optical element. The optical waveguide 22 is formed as an optical waveguide parallel to the optical waveguide 12. Therefore, similarly to the optical waveguide 12, the optical waveguide 22 extends in a direction inclined by φ in the counterclockwise direction with respect to the Z-axis direction which is the normal direction of the end face 22A. The optical waveguide 22 is provided at a position separated from the optical waveguide 12 by a distance D2 in the-X-axis direction intersecting the extending direction of the optical waveguide 22 on the substrate 101.

Hereinafter, the optical waveguide 22 is also referred to as a fourth optical waveguide. A direction parallel to the X axis in which the optical waveguide 22 is separated from the optical waveguide 12 is also referred to as a second direction. A surface parallel to the X-Y plane to which the end faces 110, 12A, and 22A belong is also referred to as a second surface. The Y-axis direction, which is an axis of inclination in the extending direction of the optical waveguide 22 with respect to the second surface to which the end face 22A of the optical waveguide 22 belongs, is referred to as a fourth direction. The counterclockwise angle φ indicating the inclination of the optical waveguide 22 is also referred to as a second angle.

The reference light intensity monitoring unit 3 receives reference light L3 incident on the optical waveguide 22 as reference light for alignment of the optical amplifier 1020. As a result, the reference light intensity monitoring unit 3 monitors the intensity of the reference light L3. Hereinafter, the reference light L3 incident on the optical waveguide 22 from the optical amplifier 1020 is also referred to as second reference light. The reference light intensity monitoring unit 3 is also referred to as a second reference light intensity monitoring unit.

As described above, in the optical element 100, it can be understood that the optical waveguides 11 and 21 are provided so as to move away from the optical waveguides 12 and 22 as they go toward the end face.

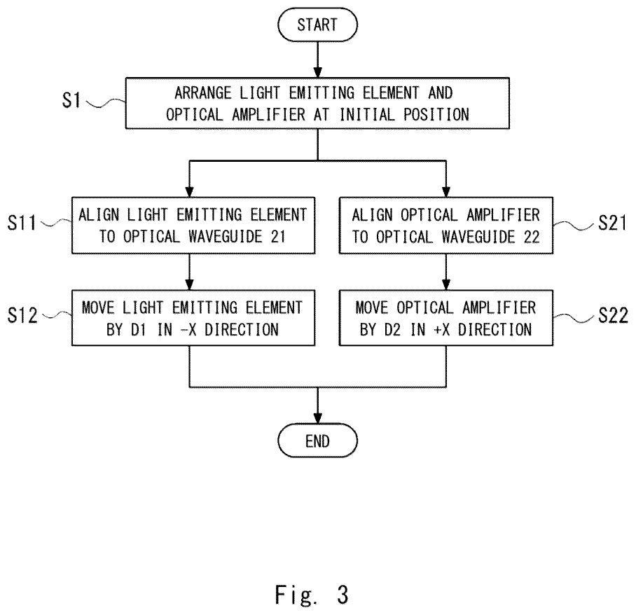

Next, alignment of the light emitting element 1010 and the optical amplifier 1020 with respect to the optical element 100 will be described. FIG. 3 is a flowchart of the alignment work according to one example embodiment. In the present example embodiment, as illustrated in FIG. 3, steps S11 and S12 related to alignment of the light emitting element 1010 and steps S21 and S22 related to alignment of the optical amplifier 1020 are performed in parallel.

### Step S1

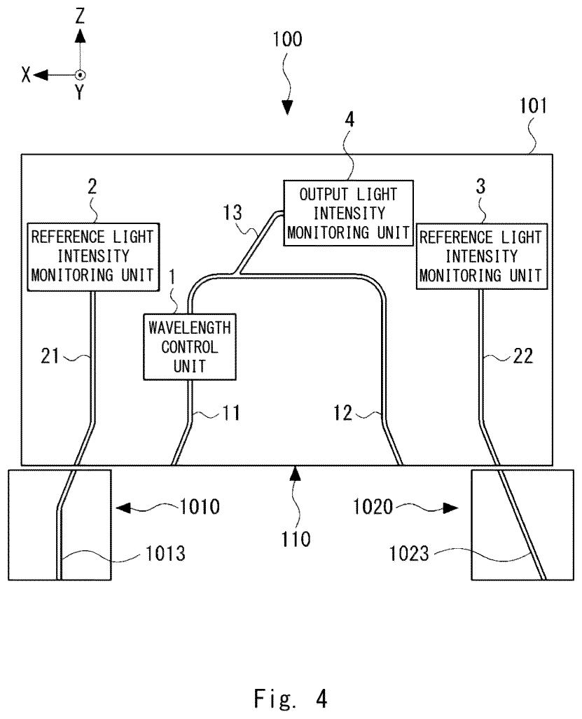

First, the light emitting element 1010 is disposed at an initial position. FIG. 4 is a diagram schematically illustrating an arrangement of an optical element, a light emitting element, and an optical amplifier at the start of alignment. Here, the light emitting element 1010 is disposed such that the end face of the optical waveguide 1013 of the light emitting element 1010 is positioned in the vicinity of the end face 21A of the optical waveguide 21. Similarly to the light emitting element 1010, the optical amplifier 1020 is disposed at the initial position. Here, the optical amplifier 1020 is disposed such that the end face of the optical waveguide 1023 of the optical amplifier 1020 is positioned in the vicinity of the end face 22A of the optical waveguide 22.

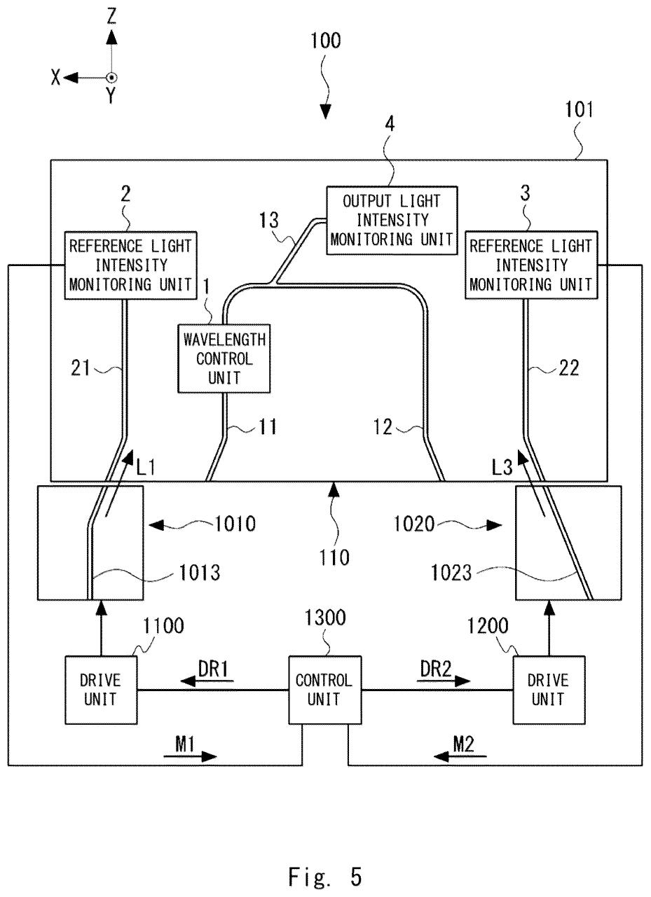

Hereinafter, the alignment work is performed by driving the light emitting element 1010 and the optical amplifier 1020 according to the monitoring result of the light intensity by the reference light intensity monitoring units 2 and 3. FIG. 5 is a diagram illustrating an example of alignment work of the light emitting element and the optical amplifier. Various driving means may be used to drive the light emitting element 1010 and the optical amplifier 1020. For example, the positions of the light emitting element 1010 and the optical amplifier 1020 may be adjusted by moving the probe while adsorbing the upper surfaces of the light emitting element 1010 and the optical amplifier 1020 with the adsorption probe. A control unit 1300 controls drive units 1100 and 1200 by providing drive signals DR1 and DR2 according to monitor signals M1 and M2 indicating the monitoring results of the light intensity by the reference light intensity monitoring units 2 and 3. As a result, the control unit 1300 can move the light emitting element 1010 and the optical amplifier 1020 to desired positions and hold the positions.

### Step S11

The control unit 1300 monitors the intensity of the input light L1 received by the reference light intensity monitoring unit 2 based on the monitor signal M1 in a state where the input light L1 is output from the light emitting element 1010. The control unit 1300 may control the output of the input light L1 from the light emitting element 1010, for example, by controlling an external power supply or the like. Then, the control unit 1300 drives the light emitting element 1010 along the horizontal direction (that is, the X-axis direction) and the vertical direction (that is, the Y-axis direction) by the drive unit 1100. The control unit 1300 holds the positional relationship between the light emitting element 1010 and the optical waveguide 21 at a position where the intensity of the input light L1 being monitored falls within a predetermined range, preferably at a position where the intensity of the input light L1 is maximized.

### Step S12

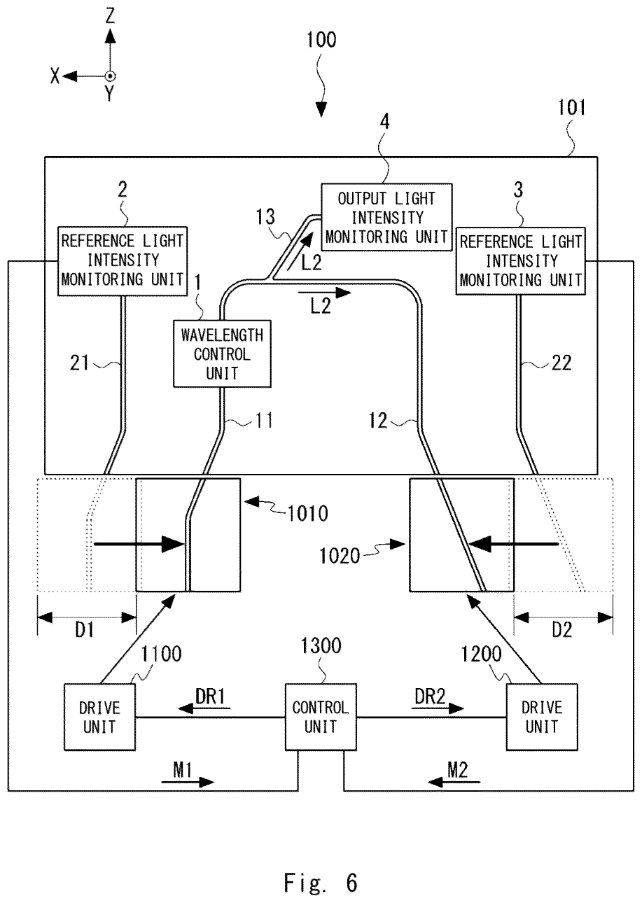

By moving the light emitting element 1010 after completion of alignment along the X axis by a predetermined distance, the optical waveguide 1013 of the light emitting element 1010 is aligned with respect to the optical waveguide 11 of the optical element 100. FIG. 6 is a diagram illustrating an example in which the light emitting element and the optical amplifier are moved to perform alignment. In this example, as illustrated in FIG. 6, the light emitting element 1010 is moved by the distance D1 in the −X-axis direction. Thus, the optical waveguide 1013 and the optical waveguide 11 can be easily aligned.

### Step S21

Upon injection of a current into the optical amplifier 1020, the active region of the optical waveguide 1023 emits light. As a result, the reference light L3 is emitted from the optical waveguide 1023 toward the optical element 100. In this state, the control unit 1300 monitors the intensity of the reference light L3 received by the reference light intensity monitoring unit 3 based on the monitor signal M2. The control unit 1300 drives the optical amplifier 1020 along the horizontal direction (that is, the X-axis direction) and the vertical direction (that is, the Y-axis direction) by the drive unit 1200. Then, the control unit 1300 holds the positional relationship between the optical amplifier 1020 and the optical waveguide 22 at a position where the intensity of the monitored reference light L3 falls within a predetermined range, preferably at a position where the intensity of the reference light L3 is maximized. The control unit 1300 may control the output of the reference light L3 from the optical amplifier 1020, for example, by controlling an external power supply or the like.

### Step S22

By moving the optical amplifier 1020 after completion of alignment along the X axis by a predetermined distance, the optical waveguide 1023 of the optical amplifier 1020 is aligned with respect to the optical waveguide 12 of the optical element 100. In this example, as illustrated in FIG. 6, the optical amplifier 1020 is moved by the distance D2 in the +X-axis direction. Thus, the optical waveguide 1023 and the optical waveguide 12 can be easily aligned.

As described above, according to the optical element 100, the alignment of the light emitting element 1010 and the alignment of the optical amplifier 1020 can be performed independently. Therefore, the alignment of the light emitting element 1010 and the alignment of the optical amplifier 1020 can be performed simultaneously in parallel.

In a case where the light emitting element and the optical amplifier are sequentially aligned with respect to the optical element by a general alignment method, it is known that a working time of several tens of minutes, for example, about 30 minutes is generally required. On the other hand, since the light emitting element and the optical amplifier can be simultaneously aligned with respect to the optical element by using the optical element 100, the working time can be shortened to ½, for example, about 15 minutes as compared with a general alignment method.

Further, in the general alignment method, during the alignment of the light emitting element 1010, the intensity of the output light L2 after the wavelength filtering in the wavelength control unit 1 is monitored by the output light intensity monitoring unit 4. Therefore, in order to stabilize the output light L2, a time for wavelength control by the wavelength control unit 1 is required. On the other hand, by using the optical element 100, the reference light intensity monitoring unit 2 monitors the intensity of the input light L1 input from the light emitting element 1010 via the optical waveguide 21. As a result, it is not necessary to control the wavelength control unit 1 in alignment of the light emitting element 1010. Therefore, by using the optical element 100, the time required for the control of the wavelength control unit 1 can be further reduced. As a result, by using the optical element 100, the working time can be shortened to about ⅓, for example, about 10 minutes as compared with a general alignment method.

Therefore, according to the optical element 100, the time required for the alignment work of the light emitting element and the optical amplifier can be greatly shortened. That is, alignment of the opposing optical paths can be efficiently performed.

### Second Example Embodiment

In the first example embodiment, the configuration in which the wavelength control unit 1 and the output light intensity monitoring unit 4 are provided in the optical element 100 has been described. However, a modulator can be incorporated in the optical element. Thus, a wavelength-tunable optical transmitter can be configured.

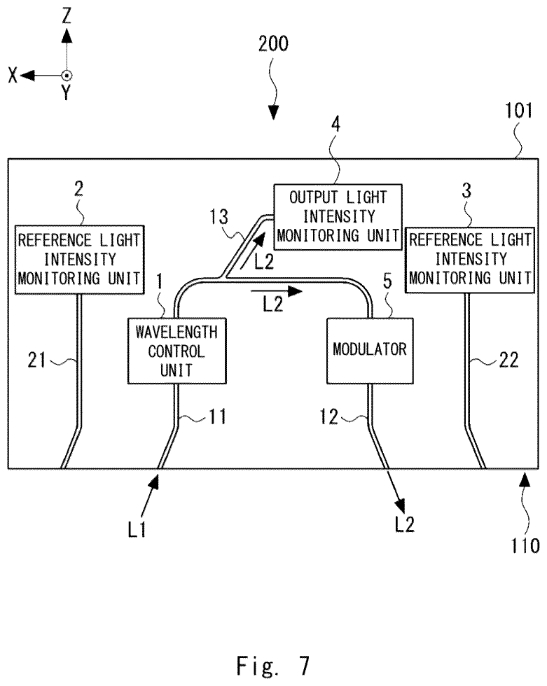

FIG. 7 is a top view schematically illustrating a configuration of an optical element according to one example embodiment. An optical element 200 according to the present example embodiment has a configuration in which a modulator 5 is added to the optical element 100 according to the first example embodiment.

The modulator 5 is inserted into the optical waveguide 12. The modulator 5 modulates the output light L2 according to, for example, a modulation signal applied from a modulator driver (not illustrated). The modulated output light L2 enters the optical waveguide 1023 of the optical amplifier 1020 from the optical waveguide 12. The optical amplifier 1020 amplifies the modulated output light L2.

The other configuration and alignment work of the optical element 200 are similar to those in the first example embodiment, and thus overlapping description is omitted.

In the optical element 200, the optical waveguides 21 and 22 used for alignment and the reference light intensity monitoring units 2 and 3 are provided independently of the wavelength control function and the modulation function of the optical element. As a result, the alignment work can be easily performed without being affected by the configuration related to the wavelength control function and the modulation function of the optical element.

### Third Example Embodiment

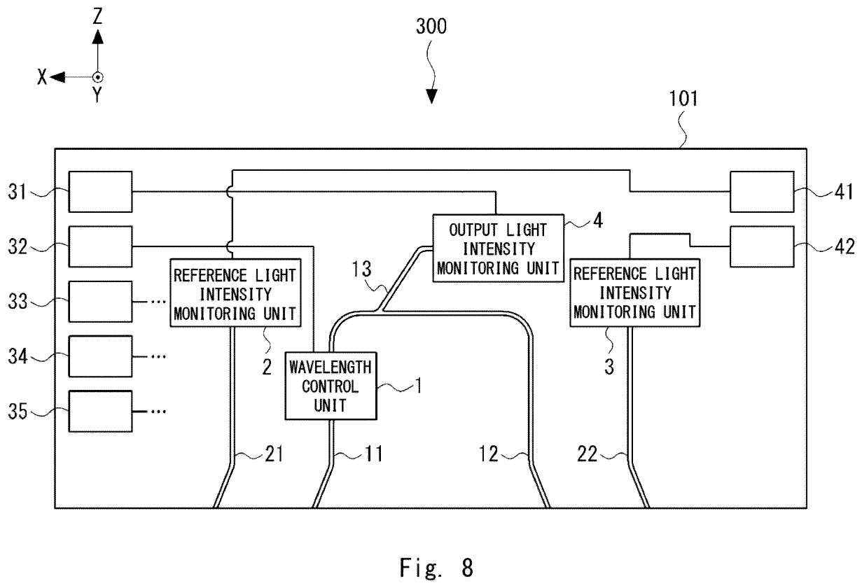

An optical element according to a third example embodiment will be described. FIG. 8 is a top view schematically illustrating a configuration of an optical element according to one example embodiment. An optical element 300 according to the present example embodiment has a configuration in which electrodes 31 to 35, 41, and 42 are added to the optical element 100 according to the first example embodiment. Hereinafter, the electrodes 31 to 35 are also referred to as a first electrode group. The electrodes 41 to 42 are also referred to as a second electrode group.

The electrodes 31 to 35 are arranged side by side in the Z-axis direction at an end portion of the substrate 101 on the +X-axis direction side where the reference light intensity monitoring unit 2 is arranged. The electrodes 31 to 35 are electrodes used for controlling the operation of the optical element 300. The electrode 31 is connected to the output light intensity monitoring unit 4. The electrode 32 is connected to the wavelength control unit 1. The electrodes 33 to 35 are connected to a component (not illustrated) such as a modulator or a control unit provided in the optical element 300. As a result, by observing the monitor signal indicating the intensity of the output light L2 output from the electrode 31 by the output light intensity monitoring unit 4, the intensity of the output light L2 can be monitored by the external device. By inputting a wavelength control signal to the electrode 32, for example, the pass band of the wavelength control unit 1 can be controlled.

The electrodes 41 and 42 are arranged at positions facing the electrodes 31 to 35 on the substrate 101. That is, the electrodes 41 and 42 are arranged side by side in the Z-axis direction at the end portion on the −X-axis direction side where the reference light intensity monitoring unit 3 is arranged. The electrodes 41 and 42 are electrodes used for alignment work of the light emitting element 1010 and the optical amplifier 1020. The electrodes 41 and 42 are connected to the reference light intensity monitoring units 2 and 3. As a result, as illustrated in FIGS. 5 and 6, the control unit 1300 can monitor the monitor signal M1 output from the electrode 31 and the monitor signal M2 output from the electrode 32.

As described above, in the optical element 300, the electrodes 31 to 35 used during operation of the optical element and the electrodes 41 and 42 used only for alignment work are physically separated from each other. As a result, the electrodes 31 to 35 used during the operation of the optical element and the electrodes 41 and 42 used only for the alignment work can be easily distinguished.

Thus, the worker who performs the alignment work can easily identify the electrodes 41 and 42 to be used. As a result, the alignment work can be shortened.

Upon mounting the optical element on a communication apparatus or the like, it is possible to reduce the possibility that the electrodes 41 and 42 used only for alignment work are mistaken for the electrodes 31 to 35 used during operation of the optical element. Thus, the occurrence of a wiring error can be suppressed.

### Other Example Embodiments

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

In the above-described example embodiment, an example in which the end face 11A of the optical waveguide 11, the end face 12A of the optical waveguide 12, the end face 21A of the optical waveguide 21, and the end face 22A of the optical waveguide 22 are provided on the same surface as the end face 110 has been described, but this is merely an example. In order to perform alignment of the light emitting element 1010, the end face 11A of the optical waveguide 11 and the end face 21A of the optical waveguide 21 may be provided on the same surface. In order to perform alignment of the optical amplifier 1020, the end face 12A of the optical waveguide 12 and the end face 22A of the optical waveguide 22 may be provided on the same surface. Therefore, the first surface to which the end faces 11A and 21A belong and the second surface to which the end faces 11A and 22A belong may be different surfaces.

Also in the optical element according to the second example embodiment, similarly to the optical element according to the third example embodiment, the electrodes 31 to 35, 41, and 42 may be provided. In the above-described example embodiment, the electrodes 31 to 35, 41, and 42 are merely examples, and any number of electrodes may be provided.

In the above-described example embodiment, an example in which the optical waveguides 11 and 21 are provided so as to be away from the optical waveguides 12 and 22 toward the end face has been described, but this is merely an example. The optical waveguides 11 and 21 may be provided so as to approach the optical waveguides 12 and 22 toward the end face. The optical waveguides 11 and 21 may be provided in parallel with the optical waveguides 12 and 22.

Each drawing is merely illustrative for describing one or more example embodiments. Each drawing is not associated with only one particular example embodiment, but may be associated with one or more other example embodiments. As those skilled in the art will appreciate, various features or steps described with reference to any one of the drawings may be combined with features or steps illustrated in one or more other drawings, for example, to create an example embodiment that is not explicitly illustrated or described. All of the features or the steps illustrated in any one of the drawings illustrating illustrative example embodiments are not necessarily mandatory, and some features or steps may be omitted. The order of the steps described in any of the drawings may be changed as appropriate.

Some or all of the example embodiments described above may be described as, but are not limited to, the following Supplementary Notes.

### (Supplementary Note 1)

An optical element including:
a first optical waveguide into which input light is incident;
a wavelength control means for performing wavelength filtering on the input light guided by the first optical waveguide and outputting output light having a desired wavelength;
a second optical waveguide that guides the output light;
an output light intensity monitoring means for monitoring an intensity of the output light guided by the second optical waveguide;
a third optical waveguide provided to be spaced apart from the first optical waveguide along a first direction intersecting a direction in which the first optical waveguide extends, the third optical waveguide being parallel to the first optical waveguide;
a first reference light intensity monitoring means for monitoring an intensity of first reference light input to the third optical waveguide;
a fourth optical waveguide provided to be spaced apart from the second optical waveguide along a second direction intersecting a direction in which the second optical waveguide extends, the fourth optical waveguide being parallel to the second optical waveguide; and
a second reference light intensity monitoring means for monitoring an intensity of second reference light input to the fourth optical waveguide, wherein
an end face on which the input light is incident in the first optical waveguide and an end face on which the first reference light is input in the third optical waveguide belong to a first surface parallel to the first direction and a third direction orthogonal to the first direction and the direction in which the first and third optical waveguides extend, and
an end face from which the output light is emitted in the second optical waveguide and an end face to which the second reference light is input in the fourth optical waveguide belong to a second surface parallel to the second direction and a fourth direction orthogonal to the second direction and the direction in which the second and fourth optical waveguides extend.
   (supplementary Note 2)

The optical element according to Supplementary Note 1, wherein
the first and third optical waveguides extend in a direction inclined at a first angle with respect to the first surface with the third direction as an axis, and
the second and fourth optical waveguides extend in a direction inclined at a second angle with respect to the second surface with the fourth direction as an axis.

### (Supplementary Note 3)

The optical element according to Supplementary Note 2, wherein
the first and second directions are the same predetermined direction,
the third and fourth directions are the same direction, and
the first and second surfaces are the same predetermined surface.

### (Supplementary Note 4)

The optical element according to Supplementary Note 3, wherein the first angle and the second angle are angles opposite to each other about the axis.

### (Supplementary Note 5)

The optical element according to Supplementary Note 4, wherein an absolute value of the first angle and an absolute value of the second angle are the same.

### (Supplementary Note 6)

The optical element according to Supplementary Note 4 or 5, wherein the first and third optical waveguides are provided away from the second and fourth optical waveguides toward the predetermined surface.

(supplementary Note 7)

The optical element according to any one of Supplementary Notes 3 to 6, further including:
a first electrode group including a plurality of electrodes including an electrode connected to at least the output light intensity monitoring means and the wavelength control means; and
a second electrode group including electrodes connected to the first and second reference light intensity monitoring means,
wherein the first electrode group and the second electrode group are provided to be separated from each other in the predetermined direction.

### (Supplementary Note 8)

The optical element according to any one of Supplementary Notes 1 to 7, wherein the second optical waveguide is provided with a light modulation means for modulating the output light.

### (Supplementary Note 9)

The optical element according to any one of Supplementary Notes 1 to 8, wherein the optical element is configured as a silicon photonics optical element formed on a silicon substrate.

### (Supplementary Note 10)

An alignment method, with respect to an optical element,
the optical element comprising:
   a first optical waveguide that guides input light;
   a wavelength control means for performing wavelength filtering on the input light guided by the first optical waveguide and outputting output light having a desired wavelength;
   a second optical waveguide that guides the output light;
   an output light intensity monitoring means for monitoring an intensity of the output light guided by the second optical waveguide;
   a third optical waveguide provided to be spaced apart from the first optical waveguide by a first distance along a first direction intersecting a direction in which the first optical waveguide extends, the third optical waveguide being parallel to the first optical waveguide;
   a first reference light intensity monitoring means for monitoring an intensity of first reference light input to the third optical waveguide;
   a fourth optical waveguide provided to be spaced apart from the second optical waveguide by a second distance along a second direction intersecting a direction in which the second optical waveguide extends, the fourth optical waveguide being parallel to the second optical waveguide; and
   a second reference light intensity monitoring means for monitoring an intensity of second reference light input to the fourth optical waveguide, in which
   an end face on which the input light is incident in the first optical waveguide and an end face on which light is input in the third optical waveguide belonging to a first surface parallel to the first direction and a third direction orthogonal to the first direction and the direction in which the first and third optical waveguides extend, and
an end face from which the output light is emitted in the second optical waveguide and an end face to which the second reference light is input in the fourth optical waveguide belonging to a second surface parallel to the second direction and a fourth direction orthogonal to the second direction and the direction in which the second and fourth optical waveguides extend,
the alignment method comprising:
performing a first alignment for aligning a first element capable of outputting light and a second alignment for aligning a second element capable of outputting light in parallel;
in the first alignment,
   adjusting a position of the first element with respect to the third optical waveguide while the first reference light intensity monitoring unit monitors an intensity of the first reference light in a state where the first reference light is output from the first element to the third optical waveguide;
   holding the first element at a position where the intensity of the first reference light falls within a predetermined first range;
   moving the first element by the first distance in a direction from a position where the first element is held toward the first optical waveguide along the first direction;
in the second alignment,
   adjusting a position of the second element with respect to the fourth optical waveguide while the second reference light intensity monitoring unit monitors an intensity of the second reference light in a state where the second reference light is output from the second element to the fourth optical waveguide;
   holding the second element at a position where the intensity of the second reference light falls within a predetermined second range; and
   moving the second element by the second distance in a direction from a position where the second element is held toward the second optical waveguide along the second direction.

What is claimed is:

1. An optical element comprising:
a first optical waveguide into which input light is incident;
a wavelength control unit configured to perform wavelength filtering on the input light guided by the first optical waveguide and to output output light having a desired wavelength;
a second optical waveguide configured to guide the output light;
an output light intensity monitoring unit configured to monitor an intensity of the output light guided by the second optical waveguide;
a third optical waveguide provided to be spaced apart from the first optical waveguide along a first direction intersecting a direction in which the first optical waveguide extends, the third optical waveguide being parallel to the first optical waveguide;
a first reference light intensity monitoring unit configured to monitor an intensity of first reference light input to the third optical waveguide;
a fourth optical waveguide provided to be spaced apart from the second optical waveguide along a second direction intersecting a direction in which the second optical waveguide extends, the fourth optical waveguide being parallel to the second optical waveguide; and
a second reference light intensity monitoring unit configured to monitor an intensity of second reference light input to the fourth optical waveguide, wherein
an end face on which the input light is incident in the first optical waveguide and an end face on which the first reference light is input in the third optical waveguide belong to a first surface parallel to the first direction and a third direction orthogonal to the first direction and the direction in which the first and third optical waveguides extend, and
an end face from which the output light is emitted in the second optical waveguide and an end face to which the second reference light is input in the fourth optical waveguide belong to a second surface parallel to the second direction and a fourth direction orthogonal to the second direction and the direction in which the second and fourth optical waveguides extend.

2. The optical element according to claim 1, wherein
the first and third optical waveguides extend in a direction inclined at a first angle with respect to the first surface with the third direction as an axis, and
the second and fourth optical waveguides extend in a direction inclined at a second angle with respect to the second surface with the fourth direction as an axis.

3. The optical element according to claim 2, wherein
the first and second directions are the same predetermined direction,
the third and fourth directions are the same direction, and
the first and second surfaces are the same predetermined surface.

4. The optical element according to claim 3, wherein the first angle and the second angle are angles opposite to each other about the axis.

5. The optical element according to claim 4, wherein an absolute value of the first angle and an absolute value of the second angle are the same.

6. The optical element according to claim 4, wherein the first and third optical waveguides are provided away from the second and fourth optical waveguides toward the predetermined surface.

7. The optical element according to claim 3, further comprising:
a first electrode group including a plurality of electrodes including an electrode connected to at least the output light intensity monitoring unit and the wavelength control unit; and
a second electrode group including electrodes connected to the first and second reference light intensity monitoring units,
wherein the first electrode group and the second electrode group are provided to be separated from each other in the predetermined direction.

8. The optical element according to claim 1, wherein the second optical waveguide is provided with a light modulation unit configured to modulate the output light.

9. The optical element according to claim 1, wherein the optical element is configured as a silicon photonics optical element formed on a silicon substrate.

10. An alignment method, with respect to an optical element,
the optical element comprising:
a first optical waveguide that guides input light;
a wavelength control unit configured to perform wavelength filtering on the input light guided by the first optical waveguide and to output output light having a desired wavelength;
a second optical waveguide that guides the output light;
an output light intensity monitoring unit configured to monitor an intensity of the output light guided by the second optical waveguide;
a third optical waveguide provided to be spaced apart from the first optical waveguide by a first distance along a first direction intersecting a direction in which the first optical waveguide extends, the third optical waveguide being parallel to the first optical waveguide;
a first reference light intensity monitoring unit configured to monitor an intensity of first reference light input to the third optical waveguide;
a fourth optical waveguide provided to be spaced apart from the second optical waveguide by a second distance along a second direction intersecting a direction in which the second optical waveguide extends, the fourth optical waveguide being parallel to the second optical waveguide; and
a second reference light intensity monitoring unit configured to monitor an intensity of second reference light input to the fourth optical waveguide, wherein
an end face on which the input light is incident in the first optical waveguide and an end face on which light is input in the third optical waveguide belonging to a first surface parallel to the first direction and a third direction orthogonal to the first direction and the direction in which the first and third optical waveguides extend, and
an end face from which the output light is emitted in the second optical waveguide and an end face to which the second reference light is input in the fourth optical waveguide belonging to a second surface parallel to the second direction and a fourth direction orthogonal to the second direction and the direction in which the second and fourth optical waveguides extend,
the alignment method comprising:
performing a first alignment for aligning a first element capable of outputting light and a second alignment for aligning a second element capable of outputting light in parallel;
in the first alignment,
adjusting a position of the first element with respect to the third optical waveguide while the first reference light intensity monitoring unit monitors an intensity of the first reference light in a state where the first reference light is output from the first element to the third optical waveguide;
holding the first element at a position where the intensity of the first reference light falls within a predetermined first range;
moving the first element by the first distance in a direction from a position where the first element is held toward the first optical waveguide along the first direction;
in the second alignment,
adjusting a position of the second element with respect to the fourth optical waveguide while the second reference light intensity monitoring unit monitors an intensity of the second reference light in a state where the second reference light is output from the second element to the fourth optical waveguide;
holding the second element at a position where the intensity of the second reference light falls within a predetermined second range; and
moving the second element by the second distance in a direction from a position where the second element is held toward the second optical waveguide along the second direction.
